(19) United States
(12) Patent Application Publication
(10) Pub. No.: US 2008/0188108 A1
(43) Pub. Date: Aug. 7, 2008

(54) Lamp Base and Electric Lamp

(76) Inventors: Gerhard Behr, Altheim (DE); Peter Helbig, Sontheim/Brenz (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/884,434

(22) PCT Filed: Feb. 6, 2006
(86) PCT No.: PCT/DE2006/000182

§ 371 Date: Aug. 15, 2007

(30) Foreign Application Priority Data
Feb. 15, 2005 (DE) 10 2005 007 048.5

(51) Int. Cl. H01R 13/52

(52) U.S. Cl. 439/271

(57) ABSTRACT

A lamp base comprising at least one lead-in wire (16). The lamp base is sealed in the area of the at least one lead-in wire (16) with at least one of the following features A, B and C. Feature A comprises an elastomer (161) or rubber that positively and annularly surrounds a section of the at least one lead-in wire (16), said section of the at least one lead-in wire (16), which is surrounded by the elastomer (161) or rubber, being positively embedded in an injection-molded plastic part (15) of the lamp base. Feature B comprises a surface area of at least one lead-in wire, which has a profile or a rough surface and is positively embedded in an injection-molded plastic part of the lamp base. Feature C comprises a section of the at least one lead-in wire, which is fitted with slots and is positively embedded in an injection molded-plastic part of the lamp base.

The invention relates to a lamp base in accordance with the precharacterizing clause of patent claim 1 and to an electric lamp having such a lamp base.

### PRIOR ART

The laid-open specification WO 97/40521 has disclosed an electric lamp having such a lamp base. This document describes a halogen incandescent lamp for a vehicle headlamp having a lamp base, which has two power supply lines for the incandescent filament. Two silicone flexible tubes are arranged in the lamp base and are used for sealing off the lamp base in the region of the two power supply lines. These silicone flexible tubes in each case surround a section of the power supply lines annularly and are arranged with a press fit between the respective power supply line and the walls of a chamber of the lamp base. This type of sealing-off is relatively complex since a chamber for the silicone flexible tubes needs to be provided in the lamp base and a mechanism for producing the press fit needs to be provided.

### DESCRIPTION OF THE INVENTION

The object of the invention is to provide a lamp base having a simplified way of sealing off the power supply lines.

This object is achieved according to the invention by the features of patent claim 1. Particularly advantageous embodiments of the invention are described in the dependent patent claims.

The lamp base according to the invention has at least one power supply line and sealing means for sealing off the lamp base in the region of the at least one power supply line, these sealing means comprising at least one of the following combinations of features A, B or C:
A. an elastomer or rubber, which surrounds a section of the at least one power supply line in an interlocking manner and annularly, this section of the at least one power supply line which is surrounded by the elastomer or rubber being embedded in a plastic injection-molded part of the lamp base in an interlocking manner,
B. a surface region of the at least one power supply line, which is provided with a profile or a roughened portion, this region of the at least one power supply line being embedded in a plastic injection-molded part of the lamp base in an interlocking manner,
C. a section of the at least one power supply line which is provided with slits, this section of the at least one power supply line being embedded in a plastic injection-molded part of the lamp base in an interlocking manner.

Each of the abovementioned combinations of features A, B or C makes it possible to seal off the lamp base in the region of the power supply lines as early as during the production of the plastic injection-molded part of the lamp base. The elastomer or rubber surrounding the at least one power supply line annularly and in an interlocking manner (combination of features A) is compressed in the injection-moulding process during production of the plastic injection-molded part and in this case bears tightly against the power supply line and against the plastic material of the plastic injection-molded part. As a result, the lamp base is sealed off from the ingress of moisture in this region.

Alternatively or in addition, a region of the at least one power supply line which is embedded in an interlocking manner in a plastic injection-molded part is provided with a surface profile or a roughened portion (combination of features B). As a result, the contact face between the at least one power supply line and the plastic material of the plastic injection-molded part is enlarged and the leakage path for the incoming moisture or gases is extended and therefore the sealing effect is increased.

Alternatively or in addition, a section of the at least one power supply line which is embedded in an interlocking manner in a plastic injection-molded part of the lamp base is provided with slits (combination of features C). As a result, the leakage path for the incoming moisture or gases is extended and therefore the sealing effect is increased.

Advantageously, a primer is provided for increasing the sealing effect. The primer is preferably arranged as an intermediate layer between the power supply line and the elastomer or rubber and applied to the section of the at least one power supply line which is provided with the surface profile or slits. The primer increases the adhesion of the plastic material of the plastic injection-molded part on the power supply line and compensates for the air gap arising on shrinkage or contraction of the plastic material.

Preferably, the abovementioned sealing means are arranged on a section of the at least one power supply line which is in the form of a sheet-metal part. The sheet-metal part makes it possible to securely anchor the power supply line in the plastic injection-molded part.

### DESCRIPTION OF THE PREFERRED EXEMPLARY EMBODIMENTS

The invention will be explained in more detail below with reference to a plurality of preferred exemplary embodiments. In the drawing:

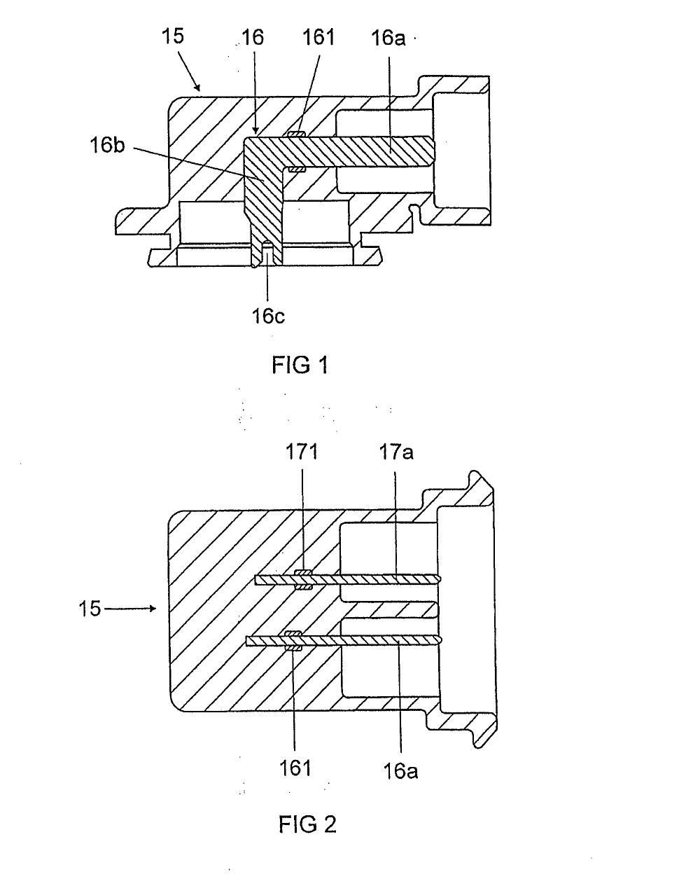

FIG. 1 shows a longitudinal section through a plastic injection-molded part of the lamp base in accordance with the first exemplary embodiment of the invention,

FIG. 2 shows a cross section through the plastic injection-molded part depicted in FIG. 1,

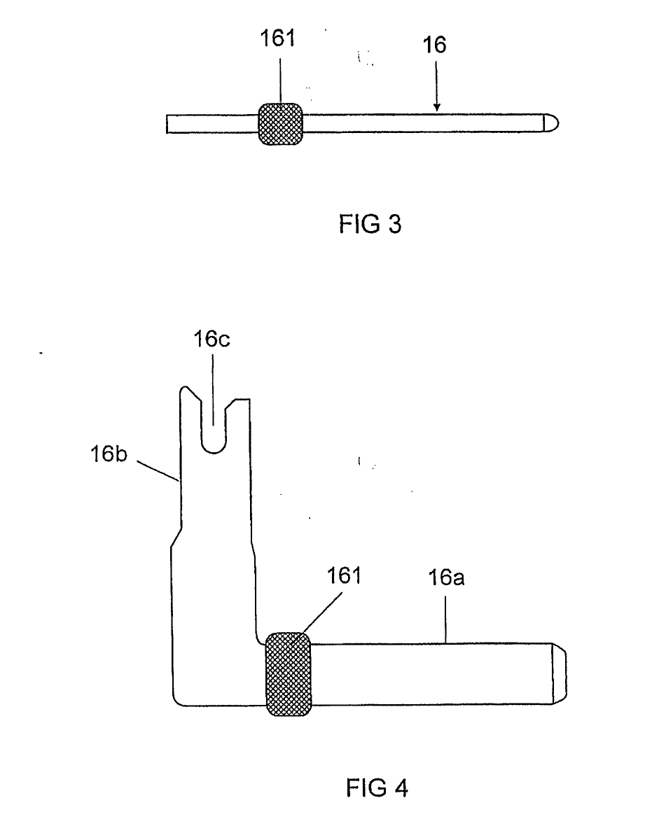

FIG. 3 shows a plan view of a power supply line of the lamp base depicted in FIG. 1,

FIG. 4 shows a side view of the power supply line depicted in FIG. 3,

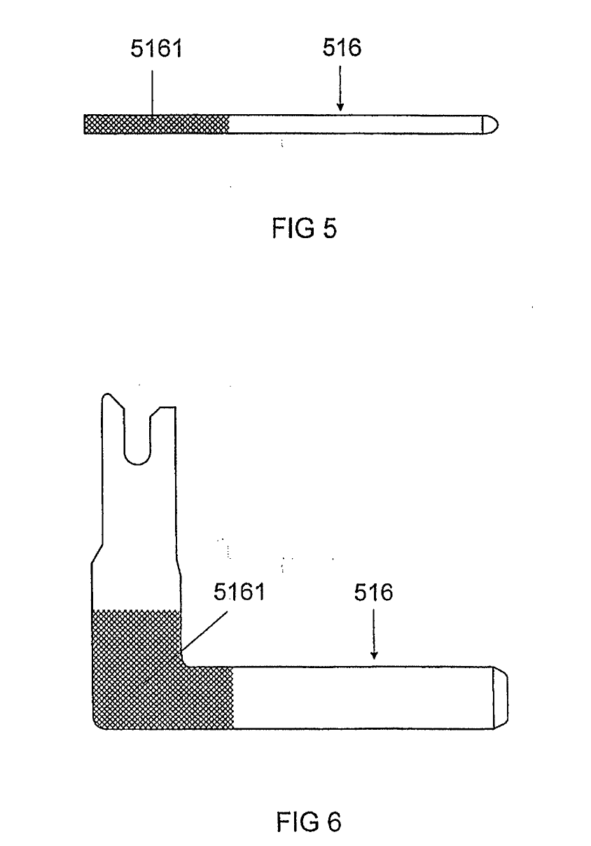

FIG. 5 shows a plan view of a power supply line in accordance with the second exemplary embodiment of the invention,

FIG. 6 shows a side view of the power supply line depicted in FIG. 5,

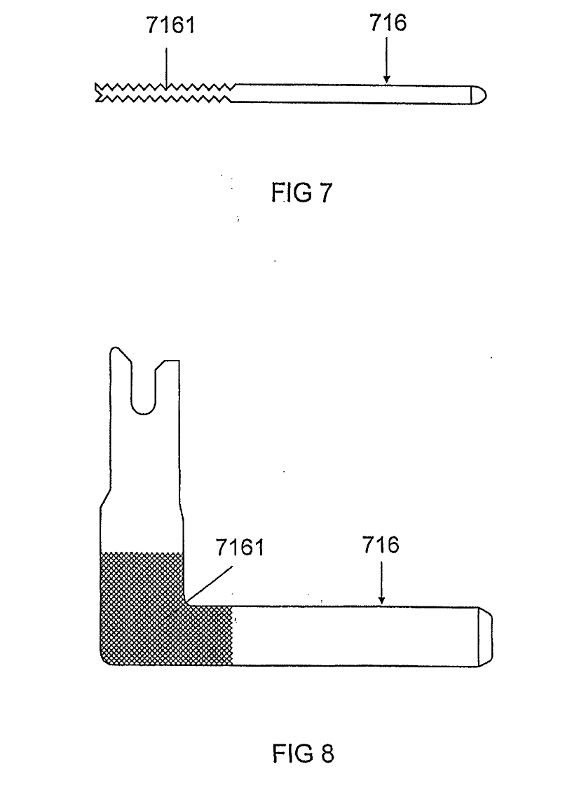

FIG. 7 shows a plan view of a power supply line in accordance with the third exemplary embodiment of the invention,

FIG. 8 shows a side view of the power supply line depicted in FIG. 7,

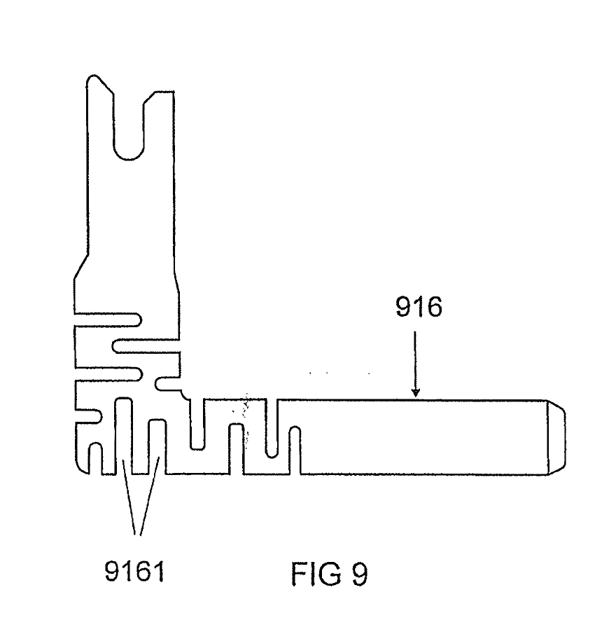

FIG. 9 shows a side view of a power supply line in accordance with the fourth exemplary embodiment of the invention, and

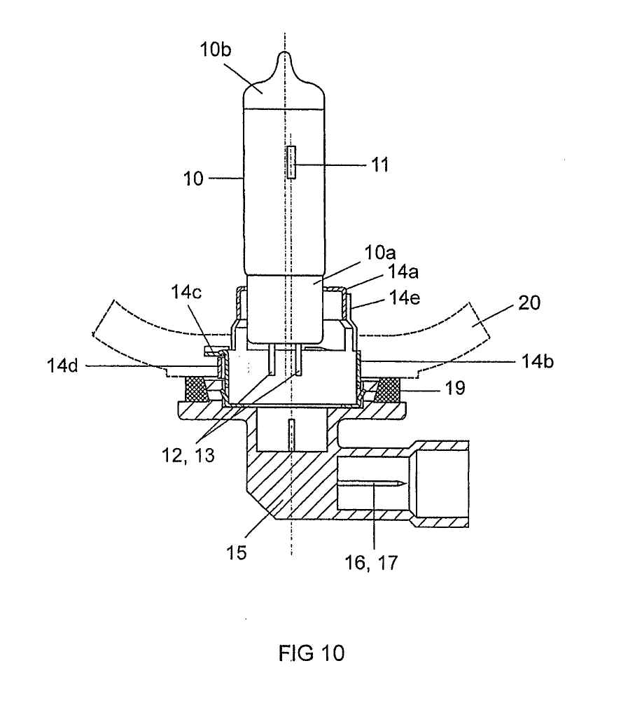

FIG. 10 shows a side view of a halogen incandescent lamp having a lamp base according to the invention.

FIGS. 1 to 4 illustrate schematically a plastic injection-molded part 15 of the lamp base and the contact lugs 16, 17 which form part of the power supply lines for the incandescent filament, in accordance with the first exemplary embodiment of the invention. This plastic injection-molded part 15 is part of the lamp base of the halogen incandescent lamp illustrated schematically in FIG. 10 which acts as a light source in a motor vehicle headlamp.

This lamp has a vitreous, substantially cylindrical lamp bulb 10 having a pinch foot 10a which is sealed in a gas-tight manner. The dome 10b of the lamp bulb 10 is provided with a light-absorbent coating. An incandescent filament 11, which is aligned parallel with the lamp bulb axis and is electrically conductively connected to two power supply wires 12, 13, which consist of molybdenum wire and are passed out of the pinch foot 10a, is used as the light source. The pinch foot 10a of the lamp bulb 10 is fixed in a metallic holder, which comprises the bowl-like holder part 14a, the intermediate ring 14e and the annular carrier sleeve 14b. In addition to the metallic holder 14a, 14b, the lamp base also has a plastic base part 15, which is provided with the electric terminals 16, 17 of the lamp and in which the annular metallic carrier sleeve 14b is anchored. The carrier sleeve 14b has three reference tabs 14c lying in one plane and a contact-pressure spring 14d for fitting the lamp in the reflector 20 of a motor vehicle headlamp. The reflector 20 is sealed off by means of a silicone sealing ring 19, which bears against the outer wall of the reflector 20 and against the plastic base part 15. FIG. 10 illustrates schematically the construction of the lamp in accordance with the preferred exemplary embodiment and its use in a headlamp.

The electrical terminals 16, 17 of the lamp comprise two metallic contact lugs 16, 17, which are each welded to one of the power supply wires 12, 13 (not depicted). The contact lugs 16, 17 are manufactured from sheet steel and injection-molded in the plastic base part 15 of the lamp base. The contact lugs 16, 17 are each made from an L-shaped steel sheet. In each case one limb 16a, 17a of the L-shaped contact lugs 16, 17 is in the form of a plug-type contact, while the other limb 16b, 17b is equipped with a groove 16c, 17c, into which in each case the bent-back end of a power supply wire 12, 13 is threaded. The angled region of the L-shaped contact lugs 16, 17 is injection-molded tightly in the plastic base part 15.

FIGS. 1 to 4 depict details of the plastic injection-molded part 15 and the contact lugs 16, 17 in accordance with the first exemplary embodiment. The two contact lugs 16, 17 are in the form of stamped sheet-metal parts. In the vicinity of the angled region, the two contact lugs 16, 17 are each coated with a primer and an elastomer 161, 171. The elastomer 161, 171 is injected onto the contact lugs 16, 17 in such a way that it surrounds the contact lugs 16, 17 in each case annularly. The primer is applied prior to the elastomer 161, 171 as an intermediate layer between the sheet metal of the respective contact lug 16, 17 and the elastomer 161, 171. The elastomer 161, 171 and the primer seal off the plastic injection-molded part in the region of the contact lugs 16, 17.

FIGS. 5 and 6 depict a contact lug 516 in accordance with the second exemplary embodiment of the invention. This contact lug 516 is in the form of an L-shaped stamped sheet-metal part. In the angled region of the contact lug 516, its surface 5161 is severely roughened. In addition, this surface region is coated with primer. The contact lug 516 is embedded in a plastic injection-molded part 15, as illustrated in the first exemplary embodiment in FIGS. 1 and 2.

FIGS. 7 and 8 depict a contact lug 716 in accordance with the third exemplary embodiment of the invention. This contact lug 716 is in the form of an L-shaped stamped sheet-metal part. In the angled region, the contact lug 716 is provided with a burled surface 7161. The burled surface region 7161 is coated with primer. The contact lug 716 is embedded in a plastic injection-molded part 15, as illustrated in the first exemplary embodiment in FIGS. 1 and 2.

FIG. 9 depicts a contact lug 916 in accordance with the fourth exemplary embodiment of the invention. This contact lug 916 is in the form of an L-shaped stamped sheet-metal part. In the angled region, the contact lug 916 is provided with a large number of slits 9161, which extend transversely with respect to the longitudinal extent of the two L limbs of the contact lug 916. That region of the contact lug 916 which is provided with the slits 9161 is coated with primer. The contact lug 916 is embedded in a plastic injection-molded part 15, as illustrated in the first exemplary embodiment in FIGS. 1 and 2.

The invention is not restricted to the exemplary embodiments explained in more detail above. For example, the contact lug 16 in accordance with the first exemplary embodiment may additionally have, in the angled region, a burled surface in accordance with the third exemplary embodiment and/or slits in accordance with the fourth exemplary embodiment. Alternatively, the contact lug 16 in accordance with the first exemplary embodiment may also have a roughened or burled surface in the region of the elastomer 161, however, with the result that the primer and the elastomer 161 are arranged on the roughened or burled surface. Instead of a burled surface, other profiles can also be used.

1. A lamp base having at least one power supply line (16) and sealing means for sealing off the lamp base in the region of the at least one power supply line (16), with the sealing means including at least one of features A, B and C,
wherein feature A comprises an elastomer (161) or rubber, which surrounds a section (16a) of the at least one power supply line (16) in an interlocking manner and annularly, this section of the at least one power supply line (16) which is surrounded by the elastomer (161) or rubber being embedded in a plastic injection-molded part (15) of the lamp base in an interlocking manner,
wherein feature B comprises a surface region of the at least one power supply line (716; 516), which is provided with a profile (7161) or a roughened portion (5161), this region of the at least one power supply line (716; 516) being embedded in a plastic injection-molded part (15) of the lamp base in an interlocking manner, and
wherein feature C comprises a section of the at least one power supply line (916) which is provided with slits (9161), this section of the at least one power supply line being embedded in a plastic injection-molded part (15) of the lamp base in an interlocking manner.

2. The lamp base as claimed in claim 1, wherein an intermediate layer, which is formed by a primer, is arranged between the elastomer (161) or rubber and the at least one power supply line (16).

3. The lamp base as claimed in claim 1, wherein a primer is arranged on the surface region of the at least one power supply line (716; 516) which is provided with the profile (7161) or the roughened portion (5161).

4. The lamp base as claimed in claim 1, wherein a primer is arranged on the section of the at least one power supply line (916) which is provided with the slits (9161).

5. The lamp base as claimed in claim 1, wherein the at least one power supply line comprises a sheet-metal part (16), and the sealing means (161) are arranged on the sheet-metal part (16).

6. An electric lamp having a lamp base as claimed in claim 1.
